(19) United States
(12) Patent Application Publication
(10) Pub. No.: US 2026/0009501 A1
(43) Pub. Date: Jan. 8, 2026

(54) GAS STORAGE USING LIQUID FOR GAS DISPLACEMENT

(71) Applicant: Fraenkel Wright Limited, Exeter Devon (GB)

(72) Inventor: Martin Thomas Ian Wright, Exeter Devon (GB)

(21) Appl. No.: 18/993,652

(22) PCT Filed: Jul. 13, 2023
(86) PCT No.: PCT/GB2023/051831

§ 371 Date: Jan. 13, 2025

(30) Foreign Application Priority Data
Mar. 8, 2022 (GB) 2211302.1
Jul. 15, 2022 (GB) 2210468.1

(51) Int. Cl. F17C 1/00

(52) U.S. Cl. CPC F17C 1/007; F17C 2201/0109; F17C 2201/032; F17C 2201/035; F17C 2203/0614; F17C 2203/0678; F17C 2221/012; F17C 2223/0123; F17C 2223/035; F17C 2223/036; F17C 2223/043; F17C 2227/0157; F17C 2227/0339; F17C 2227/0383; F17C 2250/03; F17C 2250/043; F17C 2250/0626; F17C 2250/0636; F17C 2265/025; F17C 2270/0147; F17C 2270/016

(57) ABSTRACT

Apparatus and method of storing useful gas comprising respective sources of a gas and a liquid. a sealed storage container. gas inlet and outlet means of the storage container, liquid inlet and outlet means of the storage container, and control means including a pressure monitoring device to maintain a substantially constant pressure in the storage container by control of the amount of the gas and liquid being transferred to and withdrawn from the storage container by way of the respective inlet and outlet means, wherein the gas and the liquid are immiscible so that the gas fills a space in the storage container over the liquid surface.

This invention relates to compressing and storing large volumes of pressurised gas, and, in particular, to a system for the storage of bulk quantities of combustible or valuable gases. It is a development from the Applicant's British Patent Application 2100871.9 and corresponding International Patent Application PCT/IB2022/050353.

According to a first aspect of the present invention, there is provided apparatus comprising respective sources of a gas and a liquid, a sealed storage container, gas inlet and outlet means of the storage container, liquid inlet and outlet means of the storage container, and control means including a pressure monitoring device to maintain a substantially constant pressure in the storage container by control of the amount of the gas and liquid being transferred to and withdrawn from the storage container by way of the respective inlet and outlet means, wherein the gas and the liquid are immiscible so that the gas fills a space in the storage container over the liquid surface.

According to a second aspect of the present invention, there is provided a method to compress and displace a gas stored in a sealed storage container by introducing a liquid from a liquid source into the storage container, introducing a gas from a gas source into the storage container to a desired substantially constant pressure within the storage container, wherein the gas and the liquid are immiscible so that the gas fills a space in the storage container over the liquid surface, and maintaining the substantially constant pressure by controlling the amount of liquid and gas being introduced into and withdrawn from the storage container.

Owing to these aspects, when a given volume of the gas is drawn-off from the storage container, it is replaced by an equal volume of the liquid pumped into the storage container at a pressure that maintains the gas pressure for the remaining gas in the storage container at the substantially constant pressure, regardless of how much gas is removed through the gas outlet means. Similarly, when a given volume of gas is pressurised and injected into the storage container, a similar volume of liquid is expelled from the storage container to maintain the substantially constant pressure. In this way, by storing the gas at the substantially constant pressure, almost the whole of the capacity of the storage container can be utilised, which increases the mass of gas that can be stored and delivered for a given size of storage container. This, in turn, reduces the overall cost of storing a given volume of gas.

Advantageously, the sealed storage container is an underground fabricated pressure vessel or container preferably, but not necessarily, grouted with a concrete-like material into a chamber excavated in the ground. Ground pressure is intended to enable a much lighter (and thus more economical) storage container to be used than would be necessary for a pressure vessel of similar size above ground, but the present invention could equally be applied to a suitable above-ground storage container.

In order that the present invention can be clearly and completely disclosed, reference will now be made, by way of example only, to the accompanying drawings, in which:

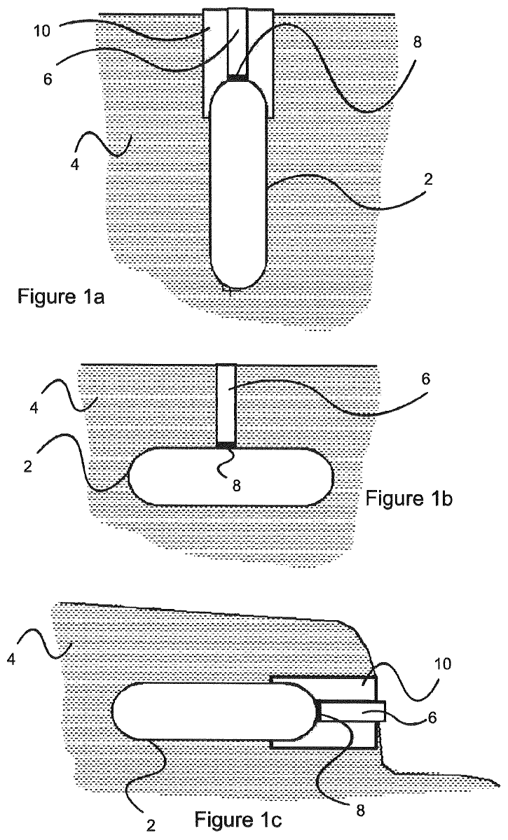

FIGS. 1a-1c are schematic illustrations of three possible configurations for installing a sealed storage container underground,

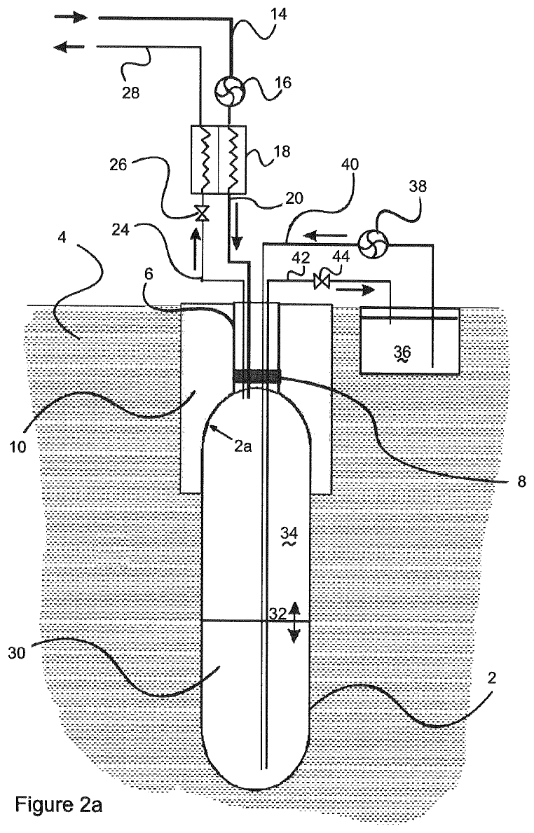

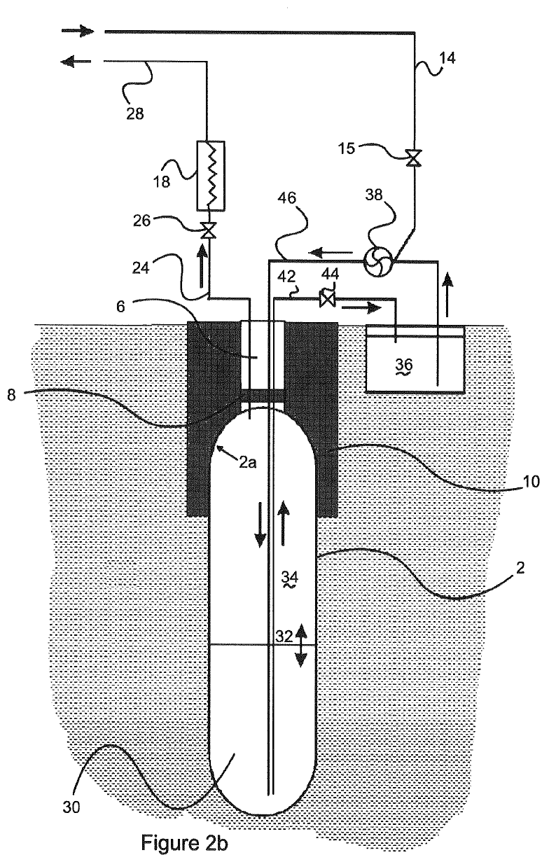

FIG. 2a is a schematic illustration of an embodiment of a bulk gas storage system using a liquid to displace a gas with an underground sealed storage container in a substantially vertical orientation,

FIG. 2b is an illustration similar to FIG. 2a, but of an alternative embodiment of the system, and

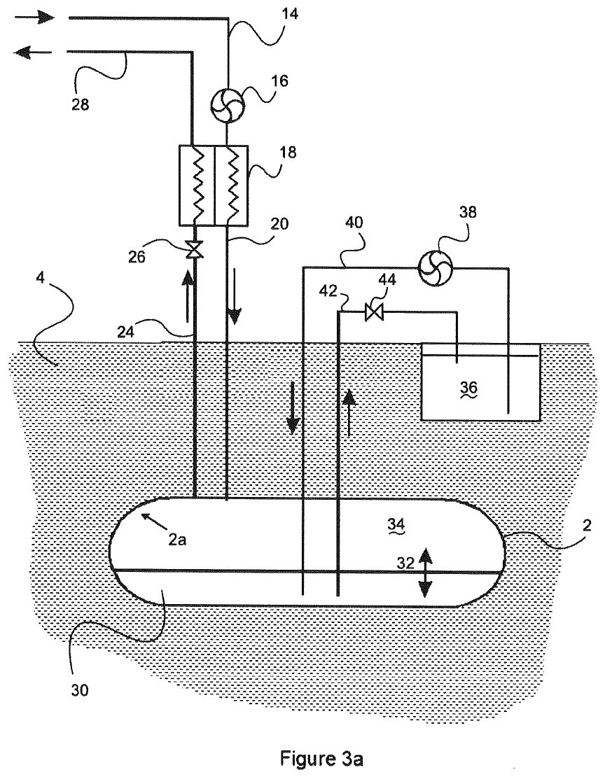

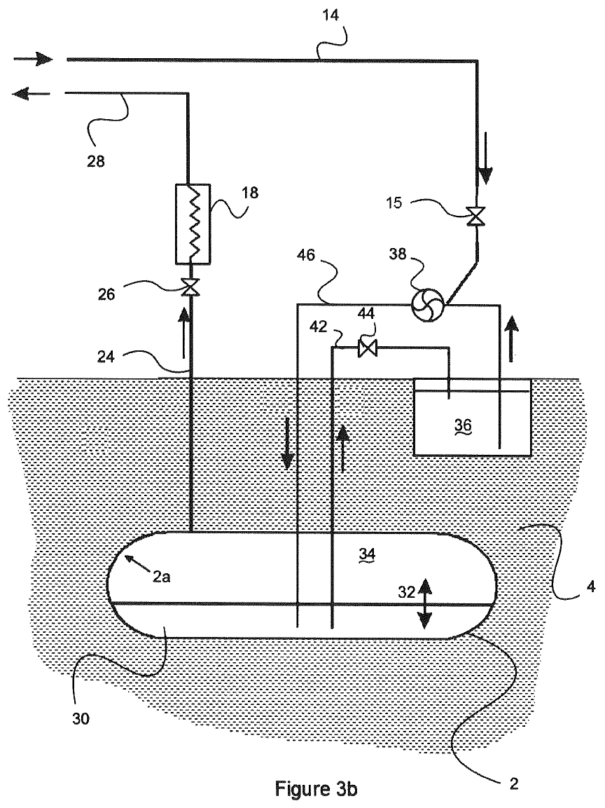

FIGS. 3a and 3b are similar illustrations to FIGS. 2a and 2b respectively, but of alternative versions of the two embodiments with the underground sealed storage container installed in a substantially horizontal orientation.

FIGS. 1a to 1c illustrate three possible configurations for storing a sealed storage container, in the form of a pressure vessel 2, underground such that the mass of the surrounding ground material 4 helps to contain the strain resulting from a stress applied to a shell of the pressure vessel, when pressurised, and thereby reduce the amount of material, such as steel, needed for manufacture of the pressure vessel 2.

In all cases, it is anticipated that the pressure vessel 2 will be preferably circular cylindrical with hemispherical ends, this being an efficient form to minimise the material requirement for the vessel 2. In addition, the pressure vessel 2 is to be substantially surrounded by the ground material 4. This can be achieved by, for example, lowering the pressure vessel 2 into a substantially vertical hole excavated from the ground surface, as in FIG. 1a. The vessel 2, if small enough, may be prefabricated and lowered complete into the hole or it may be created by initially lowering the lowest part of the vessel 2 into the excavated hole until it is almost below ground, then a sub-section can be welded or bolted or otherwise attached to the lowest part so that the vessel 2 may be lowered until the sub-section is almost down to the ground surface level when another sub-section can be attached, and so on. Once the complete vessel 2 is located in the substantially vertical hole, it can be grouted in-place by pumping, by way of grout tubes, a liquid grout material into the space between the outer surface of the pressure vessel 2 and the ground material 4 surrounding it. Once the grout material hardens the walls of the vessel 2 are intimately engaged with the ground 4 such that the geological mass of the ground 4 will prevent some of the strain resulting from stress applied to the vessel 2 when pressurised and which expands when subsequently filled with pressurised gas and liquid.

There is a potential issue with relative strain between the vessel 2 and the ground 4, and so a grout material should be used with a Youngs Modulus such that it strains similarly to the ground material 4, otherwise shearing forces may cause cracking and the development of voids between the grout material and the ground material 4 which would reduce or nullify the effectiveness of burying the pressure vessel in the ground.

Access to the pressure vessel 2 from the ground surface is provided by a shaft 6 narrower than the width of the pressure vessel 2 and this is closed off from the storage part of the pressure vessel 2 with a pressure-tight hatch or door 8 within a bulkhead.

Another feature where at least a portion of the storage part of the pressure vessel 2 is close to ground surface level is that the top part of the excavated hole may be reinforced to load the upper hemisphere of the pressure vessel 2 such that it helps to resist bursting pressure. For example, the top part of the excavated hole after installation of the pressure vessel 2 can be filled with a concrete plug 10 or the like which reinforces the upper part of the pressure vessel 2. However other means may also be applied additionally or in combination, including using a thicker material for the upper part of the vessel 2, or fitting a structural cap over the vessel 2 which may additionally be held down using, for example, by installing pre-tensioned ground anchors, or by piling extra weight on top of the cap in the form of rock or backfill material excavated from the hole.

FIG. 1b shows how the pressure vessel 2 might alternatively be installed underground in a substantially horizontal position with the access shaft 6 sealed with the pressure-tight hatch 8 similar to that described for the substantially vertically orientated vessel 2 in FIG. 1a. In this configuration, the vessel 2 would be installed such that it can be grouted in place and the surrounding ground 4 helps to prevent bursting and thereby reduces the mass of material needed for manufacture of the vessel 2. The installation process could involve installing the vessel 2 in a trench-like hole and then back-filling it, or more likely, installing it in a horizontal tunnel, as shown in FIG. 1c and then grouting it in place.

FIG. 1c shows how a substantially horizontally orientated pressure vessel 2 can be installed in a tunnel excavated into rising ground 4. In this case, the end region closest to an entry point, where ground pressure is least, may be reinforced by, for example, the concrete plug 10. As with the other configurations, the pressure vessel 2 is preferably grouted in-place to ensure intimate contact between the vessel 2 and the ground 4 so that the ground can equitably share the bursting pressure loads.

The main principles of the present invention, showing how a combination of a liquid, such as water, and a gas can be arranged to be kept at a desired pressure are illustrated in FIGS. 2a and 2b for the substantially vertical configuration for the pressure vessel 2 and in FIGS. 3a and 3b for the substantially horizontal configuration for the pressure vessel 2.

FIG. 2a shows a system where a gas, such as hydrogen for example or other fuel gases, from a gas source (not shown) is supplied through a gas delivery conduit or pipe 14 at relatively low pressure or at a gas main pressure, depending upon the nature of the source of the gas. The gas in the gas delivery pipe 14 is compressed adiabatically using a conventional gas compressor 16 which causes the compressed gas to get hotter than at source, so a heat exchanger and heat store 18 is located downstream of the compressor 16 where the relatively hot compressed gas gives up heat energy to a thermal mass (which could, for example, include a phase change material like wax, where latent heat as well as sensible heat adds to the heat energy storage capacity). Compressed gas passes from the heat exchanger and heat store 18 through a gas inlet means 20 in the form of a high-pressure gas supply conduit or pipe into the storage chamber of the pressure vessel 2.

The pressure vessel 2 preferably, but not necessarily, consists of a steel (or possibly fibre-reinforced resin, reinforced concrete or other durable material) shell 2a installed in an excavated space underground and grouted into place so that there is intimate contact between the shell 2a of the vessel 2 and the ground 4 such that the bursting pressure when the vessel 2 is charged with pressurised gas and liquid can be transmitted safely to the surrounding geological formation(s), thereby minimising the mass of material needed for manufacture of the pressure vessel 2, so that the ground 4 also acts to have the bursting forces transferred to it. In this case, as explained above, measures may be needed to make up for the reduced ground pressure at the top region of the vessel 2 so the top region may be fabricated from thicker material than the remainder of the vessel 2, and/or the plug 10 of suitable material may be provided. The access shaft 6 is sealed with the openable hatch 8 to permit access to the interior of the vessel 2 for occasional maintenance and/or repairs.

Gas outlet means 24 in the form of a gas take-off conduit or pipe can transmit pressurised gas from the vessel 2, when offtake is required, from an upper storage part of the vessel 2. The pressurised gas is passed through a pressure-reduction and non-return valve 26 where the gas is expanded to the required lower (possibly supply) pressure. This expansion causes the gas to cool and so it is passed through the heat exchanger and heat store 18 which also accepts gas being discharged from the vessel 2 by way of gas outlet means 24 which, after being dropped in pressure, gets cooled and can be warmed by absorbing heat originally provided from the gas in the gas inlet means 20.

As expanded cooler gas leaves the heat exchanger and heat store 18, the gas can be delivered as relatively low-pressure gas through a withdrawal conduit or pipe 28. The heat exchange in this way is preferable to maximise energy efficiency but it would be possible to cool the relatively hot gas in the gas inlet means 20 simply by passing it through a heat exchanger which might be air or water cooled such that the heat is simply dissipated, and similarly the cooled gas in the gas outlet means 24 could be warmed also by simply passing it through a basic heat exchanger fed with air or water at ambient temperature, or, alternatively, a small percentage of the gas could be burned to warm the expanded cooled gas.

Thus far only the gas circuit has been described, where gas is supplied, compressed, stored and can then be expanded and drawn off when needed. There is also a separate and parallel circuit to deliver a liquid 30, which in most cases but not necessarily, is water, into the pressure vessel 2 in such an arrangement where the liquid can be pumped into the vessel 2 to replace pressurised gas when it is drawn off thereby raising a liquid level 32 in the vessel 2 such that the gas pressure in a space 34 above the liquid 30 can be maintained at a substantially constant level regardless of the volume of gas present in the vessel 2. Similarly, when compressed gas is admitted into the vessel 2, liquid can be released thereby lowering the liquid level 32 such that constant pressure within the chamber is maintained as will be explained in more detail below.

The liquid circuit includes a source of liquid 36 at or above the surface of the ground. The liquid, which is incompressible, is drawn from the source 36 by using a pump 38, preferably in the form of a high-pressure pump and delivered internally of the vessel 2 via a liquid inlet means 40 in the form of a liquid supply pipe, that extends to the bottom region of the internal storage volume of the vessel 2.

The gas and the liquid are immiscible, so gas fills the space 34 over the surface 32 of the liquid.

A control system (not illustrated), including one or more pressure monitoring devices and, possibly, other suitable sensor devices and/or transducers, monitors and responds to signals from the pressure monitoring device and further sensor devices and/or transducers and causes the pump 38 to pump water into the vessel 2 when stored pressurised gas is removed from the vessel 2 so as to replace the volume of gas removed. The main parameter being controlled by the control system is the gas pressure in the vessel 2 which is readily monitored.

When the gas is being supplied from the gas source to (partially) re-fill the vessel 2, the liquid circuit includes liquid outlet means 42 in the form of a liquid take-off conduit or pipe which includes a valve 44 that can be opened automatically, by way of the control system, to allow the liquid under pressure to rise through liquid outlet means 42 and preferably return it to the liquid source 36. The valve 44 may also include means to reduce the water pressure before the water is returned to the liquid source 36.

Although the liquid source 36 is depicted as a reservoir of some kind such that liquid may be recirculated, it is equally possibly to take the liquid from a continuous source such as a water main or a river and to return the liquid emitted from the storage container to a continuous drainage system so that instead of being recirculated the liquid is directed through the system one time and subsequently disposed of.

Thus, when pressurised gas is added or removed from the vessel 2, a similar volume of liquid can be added or removed at the same rate, such that the pressure in the vessel 2 remains substantially constant. This is achieved by the pressure monitoring device(s) of the control system causing appropriate inputs and outputs of gas and liquid by activating and adjusting one or more pumps and/or valves appropriately.

FIG. 2b illustrates a similar but alternative embodiment. In this embodiment, the gas from the source of gas, at relatively low pressure, is fed via the gas delivery conduit or pipe 14 via a controllable valve 15 into the suction side of the pump 38 where it mixes with the liquid being drawn from the source of liquid 36. The resultant mixture of liquid carrying entrained gas bubbles of the gas is pressurised by the pump 38 and transmitted into the vessel 2 along a combined gas and liquid inlet means 46 in the form of a gas and liquid supply conduit or pipe. This process avoids the considerable increase in temperature of adiabatic compression and thereby approximates to an isothermal compression technique.

As previously mentioned, the gas and the liquid are immiscible so the gas bubbles out of the liquid once in the vessel 2 and fills the space 34 over the surface 32 of the liquid. As previously explained, this involves approximately isothermal compression of the gas in the liquid carrier and so, although the gas will increase in temperature, such an increase is not as great as in the embodiment of FIG. 2a. A further heat exchanger (not illustrated) can be provided within or surrounding the vessel 2 or externally of the combined gas and liquid inlet means 46 to remove the lesser quantity of heat energy. This heat could be delivered for useful purposes above ground possibly via a heat pump or it could be fed through an air-cooled heat exchanger and simply dissipated, or it could go to the heat store 18 used to warm the drawn-off expanded gas which would otherwise possibly be excessively cooled.

When off-take of gas is required, the gas can be exported through the gas outlet means 24 by opening valve 26. Valve 26 is a pressure reduction valve to allow rapid expansion of the gas which will make the gas cooler, so the heat exchanger and heat store 18 can be arranged to restore the gas to substantially ambient temperature from where it can be delivered via the withdrawal conduit or pipe 28. The heat exchanger and heat store 18 can alternatively be arranged to burn a small fraction of the gas or be heated from other sources including the aforementioned further heat exchanger in or surrounding the vessel 2 or the combined gas and liquid inlet means 46.

The supply of the liquid at relatively high pressure to compensate for gas being drawn off from the vessel 2 is controlled by the control system arranged so that when gas needs to be injected into the vessel 2, it is mixed with the liquid to pressurise it and feed it into the vessel 2 through the combined gas and liquid inlet means 46 and liquid is also drawn off through the liquid outlet means 42 to compensate for extra volumetric space in the vessel 2 made available for the gas. The control system is largely managed by the pressure monitoring device reacting to changes by adjusting the compressor 16, the pump 38, and the valves 15, 26 and 44 appropriately, thereby controlling gas off-take while allowing the liquid out if the pressure in the vessel 2 gets too high and pumping more liquid into the vessel 2 if the pressure in the vessel 2 gets too low while also adjusting the quantity of gas to be mixed with the liquid using the controllable valve 15.

Advantageously, the gas inlet and outlet means 20, 24 or the combined gas and liquid inlet means 46, the liquid inlet and outlet means 40, 42 and other services such as cables to the control system, etc., are located in the shaft 6 and penetrate the bulkhead carrying the access hatch 8 in a sealed and gas-tight manner.

Referring to FIGS. 3a and 3b, the arrangement is similar to those arrangements shown and already explained with regard to FIGS. 2a and 2b respectively, except that in FIGS. 3a and 3b the pressure vessel is installed substantially horizontally, possibly in a tunnel, and while access of some form will need to be provided, this is not illustrated. However, FIGS. 1b and 1c illustrate how such access can be obtained.

The same principles applying to the underground pressure vessel would also be applicable to a pressure vessel that is located above ground level. Keeping the pressure vessel 2 at substantially constant pressure, even when located entirely above ground level, will also be beneficial in terms of raising the average mass of gas that can be delivered per charge of the vessel 2 and of reducing the fatigue cycles and thereby increasing the useful service life of a given pressure vessel. In such a situation, the vessel 2 such as that shown in FIGS. 3a and 3b in a substantially horizontal configuration can be mounted on suitable supports above ground. The casing or shell of the vessel will have to be designed to carry the maximum bursting pressure for a suitable number of fatigue cycles. With an above ground pressure vessel, there is no ground pressure to help contain the pressure, and so it may be advantageous to include circumferential flanges to reinforce such a pressure vessel along with other such measures known to be beneficial with pressure vessels. The liquid and gas supply circuits can be similar to those illustrated in FIGS. 3a and 3b. Thus, by substantially maintaining substantially constant pressure when charging and discharging the pressure vessel, the cyclic variations in stress in the vessel, which would occur if the pressure were allowed to decline when discharging gas and increase when recharging the vessel, are reduced. Therefore, the pressure vessel will only experience de-pressurisation occasionally when maintenance or inspection is needed and therefore the fatigue life of not only the vessel but also the grout surrounding it will be very much improved.

The systems described above have two major benefits in that:
firstly, the pressure in the vessel 2 is maintained at a desired substantially constant level which will tend to increase the fatigue life of the vessel 2 compared with if the pressure was allowed to fall significantly every time gas is drawn off by reducing the number of pressurisation and depressurisation cycles the vessel will have to endure. Reducing the number of pressurising and discharging cycles means that either the vessel 2 can be thinner-walled and cheaper or it can last much longer or both. Pressure vessels have a fatigue life depending on the material strength (thickness) and number of cycles they undergo.
secondly, because it is possible to displace substantially all of the gas from the vessel 2 with the liquid, there is no need to leave a “cushion” or “residual” volume of gas in the vessel 2, as would happen if gas is drawn off until the pressure in the vessel 2 reaches the delivery pressure in the withdrawal conduit or pipe 28 which is significantly lower than the storage pressure.

By storing the gas at substantially constant pressure, almost the whole of the storage capacity of the vessel 2 can be utilised, which increases the mass of gas that can be stored and delivered in a given size of pressure vessel. This, in turn, allows substantially more gas to be delivered compared with when allowing the gas pressure in the vessel to fall to the delivery pressure and leaving the entire pressure vessel filled with what is known as a “cushion” volume of gas at the supply or delivery pressure since once the pressure in the vessel 2 falls to the delivery pressure, no more gas can come out of the vessel 2, so the entire vessel is left full of gas at (slightly above) the delivery pressure. In the latter case, the average pressure is about half way between a charging pressure (which could, for example, be 200 bar) and a delivery pressure (which may be 70 bar as for a mains gas grid or as low as 10 bar for a local supply), whereas with the present invention, the pressure remains at approximately the charging pressure (e.g. 200 bar) so a much greater mass (tonnage) of gas can be delivered from a single charge, thereby significantly increasing the energy storage capacity compared with a storage where the gas pressure is allowed to decline from the charge pressure to the supply pressure.

1. Apparatus comprising respective sources of a gas and a liquid, a sealed storage container, gas inlet and outlet means of the storage container, liquid inlet and outlet means of the storage container, and control means including a pressure monitoring device in order to maintain a substantially constant pressure in the storage container by control of the amount of the gas and liquid being transferred to and withdrawn from the storage container by way of the respective inlet and outlet means, wherein the gas and the liquid are immiscible so that the gas fills a space in the storage container over the liquid surface.

2. Apparatus according to claim 1, wherein the sealed storage container is an underground container.

3. Apparatus according to claim 2, wherein the underground container is grouted with a concrete-like material into a chamber excavated in the ground.

4. Apparatus according to claim 1, wherein the container is circular cylindrical with hemispherical ends.

5. (canceled)

6. Apparatus according to claim 2, wherein the container is installed underground in a substantially horizontal orientation.

7. Apparatus according to claim 6, wherein the substantially horizontally orientated container is installed in a tunnel excavated into rising ground.

8. Apparatus according to claim 2, wherein the container is installed underground in a substantially vertical position.

9. Apparatus according to claim 1, wherein the gas and liquid inlet means is a combined gas and liquid inlet means.

10. (canceled)

11. Apparatus according to claim 1, wherein—the control means includes a control system and—the control system monitors and responds to signals from the pressure monitoring device and further sensor devices and/or transducers.

12. A method to compress and displace a gas stored in a sealed storage container by introducing a liquid from a liquid source into the storage container, introducing a gas from a gas source into the storage container to a desired substantially constant pressure within the storage container, wherein the gas and the liquid are immiscible so that the gas fills a space in the storage container over the liquid surface, and maintaining the substantially constant pressure by controlling the amount of liquid and gas being introduced into and withdrawn from the storage container.

13. A method according to claim 12, wherein when a given volume of the gas is drawn-off from the storage container, it is replaced by an substantially equal volume of the liquid pumped into the storage container at a pressure that maintains the gas pressure for the remaining gas in the storage container at the substantially constant pressure, regardless of how much gas is removed through the gas outlet means, and wherein when a given volume of gas is injected into the storage container, a similar volume of liquid is expelled from the storage container to maintain the substantially constant pressure.

14. A method according to claim 12, wherein said maintaining includes monitoring the substantially constant pressure by a control system, the control system including a pressure monitoring device, and causing appropriate inputs and outputs of gas and liquid by appropriately activating and adjusting one or more pumps and/or valves.

15. A method according to claim 12, and further comprising excavating a hole in the ground and installing the storage container in the excavated hole in a substantially vertical orientation and subsequently filling any void space between the container and the surrounding ground with a grout material so that the surrounding ground carries some of the strain resulting from pressurising the container.

16. A method according to claim 15, wherein the storage container is prefabricated and lowered complete into the excavated hole prior to grouting it into place.

17. A method according to claim 15, wherein the storage container is installed by, initially, lowering a lowest part of the container into the excavated hole until it is almost below ground, and subsequently attaching one or more container subsections until the container is complete and below the surface of the ground, such that the complete container is assembled during the installation procedure and can subsequently be grouted into place by filling the voids between the container and the surrounding ground with grout.

18. A method according to claim 12, wherein the installation of the storage container is by excavating a trench-like hole and installing the storage container in a substantially horizontal orientation and then back-filling the hole and subsequently filling any void space between the container and the surrounding ground with a grout material so that the surrounding ground carries some of the strain resulting from pressurising the container.

19. A method according to claim 12, wherein the installation of the storage container is by inserting the storage container in a substantially horizontal tunnel and subsequently filling any void space between the container and the surrounding ground with a grout material so that the surrounding ground carries some of the strain resulting from pressurising the container.

20. (canceled)

21. (canceled)

22. A method according to claim 15, wherein a shell of the storage container installed in an excavated space underground and grouted into place, there being intimate contact between the shell of the storage container and the ground, transmits pressure when the storage container is charged with pressurised gas and liquid to the surrounding geological formation(s), thereby minimising the mass of material needed for the storage container.

23. A method according to claim 12, wherein the gas is fed to the storage container via a controllable valve into a suction side of a pump for feeding the liquid to the storage container, thereby mixing the gas with the liquid, the liquid carrying entrained gas bubbles of the gas being pressurised by the pump and transmitted into the storage container along a combined gas and liquid inlet means and wherein the liquid settles in the lower part of the container and the gas in the upper part.

24. A method according to claim 23, wherein when gas needs to be transferred into the storage container, it is mixed with the liquid to pressurise the gas, and liquid is also drawn off through the liquid outlet means to compensate for extra volumetric space in the storage container made available for the gas and liquid.
